(19) United States
(12) Patent Application Publication
(10) Pub. No.: US 2005/0197816 A1
(43) Pub. Date: Sep. 8, 2005

(54) Circuit simulation system with simulation models assigned based on layout information and connection information

(75) Inventors: Takashi Inukai, Kanagawa (JP); Yukihiro Urakawa, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 10/915,435

(22) Filed: Aug. 11, 2004

(30) Foreign Application Priority Data
Mar. 4, 2004 (JP) P2004-060678

(51) Int. Cl. G06G 7/62

(52) U.S. Cl. 703/14

(57) ABSTRACT

A circuit simulation system for simulating an integrated circuit includes a circuit behavior analysis module analyzing behavior information of a circuit element of the integrated circuit based on connection information; a model selection module selecting a circuit element model corresponding to the circuit element from the library area based on location information and behavior information of the circuit element; a circuit generation module generating a to-be-analyzed circuit using the selected circuit element model; and a circuit simulation module executing the to-be-analyzed circuit simulation.

### CROSS REFERENCE TO RELATED APPLICATIONS

This application is based upon and claims the benefit of priority from prior Japanese Patent Application P2004-060678 filed on Mar. 4, 2004; the entire contents of which are incorporated by reference herein.

### BACKGROUND OF THE INVENTION

1. Field of the Invention

The present invention relates to a design method of an integrated circuit, particularly to a circuit simulation system, a circuit simulation method and a circuit simulation program.

2. Description of the Related Art

In circuit simulation used for system circuit design, circuit elements such as transistors are classified according to characteristics thereof such as active region threshold voltage or polarity determined depending on the fabrication method. A unique circuit element model is provided for each category. However, there is a significant difference in characteristics between circuit elements classified in the same category due to the influence of adjacent circuit elements as a result of miniaturization of a semiconductor device.

A plurality of transistors simultaneously being switched to be brought into conduction is called ‘simultaneous switching’. Differences in current flowing through the transistors that have been brought into conduction may occur between simultaneously switched transistors sharing an electrode region and only one of the transistors being brought into conduction. Here, ‘share an electrode region’ means that the electrodes of a plurality of transistors are deployed in a single active region electrically isolated from another active region via an insulator film or the like.

For example, the interface resistance of silicide formed on the source region of a MOS transistor increases as the semiconductor device is miniaturized, resulting in an increase in the parasitic resistance of the source electrode region. Therefore, in the case of a primary and a secondary MOS transistor sharing the source electrode region, the amount of drain current when the primary MOS transistor has been brought into conduction depends on whether the secondary MOS transistor is simultaneously brought into conduction or is brought out of conduction.

This is because when current flows through two MOS transistors simultaneously, double current flows through the parasitic resistance of the common source electrode region, resulting in a difference in the amount of voltage drop. In other words, the characteristics of the primary MOS transistor that has been brought into conduction may differ depending on whether or not the primary and the secondary MOS transistor are simultaneously switched.

The following are circuit simulation methods considering changes in transistor characteristics due to the behavior of other transistors sharing the electrode region.

(i) A method for executing circuit simulation by adding the parasitic resistance as a partial circuit to a to-be-analyzed circuit, which is represented by the description of electrical connection relationships among the elements.

(ii) A method of providing circuit element models for transistors that include parasitic resistances as parameters and then executing circuit simulation in both cases when the influence of the behaviors of the other transistors sharing the electrode region become maximum and minimum. To execute this circuit simulation, circuit element models for transistors that include parasitic resistances as parameters should be provided for the cases where current flowing through the parasitic resistance become maximum and minimum due to the influence of the behaviors of the other transistors sharing the electrode region, respectively.

On the other hand, the characteristics of transistors may also be influenced by layout patterns of the circuit elements in addition to the simultaneous switching. Therefore, the Binning method is used for circuit simulation considering circuit layout patterns (Yuhua Cheng, Chenming Hu, ‘MOSFET MODELING & BSIM3 USER'S GUIDE’, Klumer Academic Pub, 1999).

Nevertheless, with method (i), the number of elements in the to-be-analyzed circuit increases, resulting in an increase in analysis time.

On the other hand, with method (ii), since circuit simulation assumes that all circuit states are executed, the circuit design has a large design margin, resulting in inhibition of a high-performance semiconductor device.

In addition, the characteristics of the circuit elements may differ due to temperature dependence on the circuit elements in the case of a large or a small power consumption emanating from circuit behavior of adjacent circuit blocks. Furthermore, the characteristics of the adjacent circuit elements may differ due to the influence of the amount of noise generated in the circuit blocks. Since not only circuit layout information but also circuit behavior information is needed to consider such influences upon the circuit elements from the circuit behavior of the adjacent circuit blocks, highly accurate circuit simulation cannot be executed by the Binning method.

### SUMMARY OF THE INVENTION

An aspect of the present invention inheres in a circuit simulation system for simulating an integrated circuit, including a data memory unit configured to include a library area storing a plurality of circuit element models and a connection information area storing connection information of an integrated circuit; a circuit behavior analysis module configured to analyze behavior information of a circuit element of the integrated circuit based on the connection information; a model selection module configured to select a circuit element model corresponding to the circuit element from the library area based on location information and the behavior information of the circuit element; a circuit generation module configured to generate a to-be-analyzed circuit using the selected circuit element model; and a circuit simulation module configured to execute the to-be-analyzed circuit simulation.

Another aspect of the present invention inheres in a computer implemented method for simulating an integrated circuit, including generating a plurality of circuit element models for a single circuit element, and storing the circuit element models in a library area; analyzing behavior information of a circuit element of the integrated circuit based on connection information of the integrated circuit; selecting a circuit element model for the circuit element from the library area based on location information and the behavior information of the circuit element; generating a to-be-analyzed circuit using the circuit element model; and executing the to-be-analyzed circuit simulation.

Still another aspect of the present invention inheres in a computer program product for executing a circuit simulation, including instructions configured to analyze behavior information of a circuit element of an integrated circuit based on connection information of the integrated circuit; instructions configured to select a circuit element model for the circuit element from a library area based on location information and the behavior information of the circuit element; instructions configured to generate a to-be-analyzed circuit using the circuit element model; and instructions configured to execute the to-be-analyzed circuit simulation.

### BRIEF DESCRIPTION OF DRAWINGS

FIG. 1 is a view showing a schematic of a circuit simulation system according to a first embodiment of the present invention;

FIG. 2 is a view showing a schematic circuit configuration to explain a simulation method according to the first embodiment of the present invention;

FIGS. 3A, 3B, 3C are schematic views showing examples of a circuit element model for a circuit element of the circuit simulation system according to the first embodiment of the present invention;

FIGS. 4A, 4B, 4C are schematic views showing examples of a circuit element model for another circuit element of the circuit simulation system according to the first embodiment of the present invention;

FIG. 5 is a table showing a combination to select a circuit element model for the circuit element of the circuit simulation system according to the first embodiment of the present invention;

FIGS. 6A, 6B, 6C are schematic views showing examples of a circuit element model and a parasitic resistance for a circuit element of the circuit simulation system according to the first embodiment of the present invention;

FIGS. 7A, 7B, 7C, 7D, 7E are schematic views showing examples of a circuit element model and a parasitic resistance for another circuit element of the circuit simulation system according to the first embodiment of the present invention;

FIG. 8 is a schematic view showing an example of a to-be-analyzed circuit generated by the circuit simulation system according to the first embodiment of the present invention;

FIG. 9 is a flowchart to explain the simulation method according to the first embodiment of the present invention;

FIG. 10 is a view showing a schematic of a circuit simulation system according to a second embodiment of the present invention;

FIG. 11 is a flowchart to explain a method of calculating a change in the temperature of a circuit element emanating from the power consumption of the circuit block using the circuit simulation system according to the second embodiment of the present invention;

FIG. 12 is a flowchart to explain the simulation method considering the influence of power consumption of the circuit block according to the second embodiment of the present invention;

FIG. 13 is a flowchart to explain another simulation method considering the influence of power consumption of the circuit block according to the second embodiment of the present invention;

FIG. 14 is a flowchart to explain a method of calculating a circuit element emanating from the generated noise of the circuit block using the circuit simulation system according to the second embodiment of the present invention; and

FIG. 15 is a flowchart to explain the simulation method considering the influence of the generated noise of the circuit block according to the second embodiment of the present invention.

### DETAILED DESCRIPTION OF THE INVENTION

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

In the following descriptions, numerous specific details are set fourth such as specific signal values, etc. to provide a thorough understanding of the present invention. However, it will be obvious to those skilled in the art that the present invention may be practiced without such specific details. In other instances, well-known -circuits have been shown in block diagram form in order not to obscure the present invention in unnecessary detail.

### First Embodiment

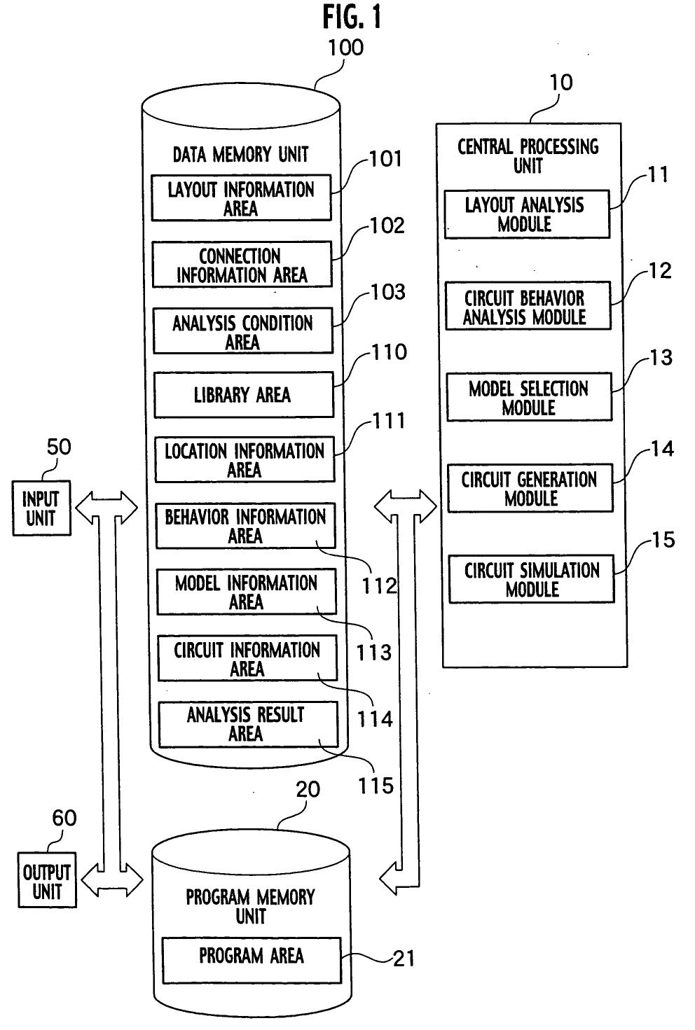

As shown in FIG. 1, a circuit simulation system according to the first embodiment of the present invention includes a CPU 10, a program memory unit 20, a data memory unit 100, an input unit 50, and an output unit 60.

The data memory unit 100 includes a layout information area 101, a connection information area 102, an analysis condition area 103, a library area 110, a location information area 111, a behavior information area 112, a model information area 113, a circuit information area 114, and an analysis result area 115. The layout information area 101 stores layout information for circuit elements of integrated circuits to be subjected to circuit simulation. Layout information includes information such as coordinates of the active region and coordinates corresponding to the layouts of circuit elements. The connection information area 102 stores electrical connection information of an integrated circuit to be subjected to circuit simulation. The analysis condition area 103 stores analysis conditions, such as input signal conditions, temperatures, and analysis errors, and specifications of output formats for executing circuit simulation. The library area 110 stores a plurality of circuit element models for circuit elements. The location information area 111 stores location information for the circuit elements of the integrated circuits. The behavior information area 112 stores behavior information of the circuit elements of the integrated circuits. The model information area 113 stores information of circuit element models selected for the circuit elements of the integrated circuits. The circuit information area 114 stores information of a to-be-analyzed circuit. The analysis result area 115 stores the results of circuit simulation.

The program memory unit 20 includes a program area 21 in which circuit simulation programs are stored.

The CPU 10 includes a layout analysis module 11, a circuit behavior analysis module 12, a model selection module 13, a circuit generation module 14, and a circuit simulation module 15. The layout analysis module 11 analyzes circuit element layout information stored in the layout information area 101, and extracts circuit element location information. The circuit behavior analysis module 12 reads circuit connection information stored in the connection information area 102 so as to analyze circuit behavior, and extracts information such as conduction states of the circuit elements. The model selection module 13 selects respective circuit element models corresponding to the circuit elements from the library area 110 in conformity with the circuit element location information stored in the location information area 111 and the circuit element behavior information stored in the behavior information area 112. A ‘circuit element model’ is a circuit element, which configures an integrated circuit, modeled according to electrical characteristics, which allow a circuit simulation system to analyze. The circuit generation module 14 reads connection information stored in the connection information area 102, and generates a to-be-analyzed circuit using the circuit element models stored in the library area 110 while referencing information on the circuit element models selected for the corresponding circuit elements stored in the model information area 113. The circuit simulation module 15 reads the to-be-analyzed circuit stored in the circuit information area 114, analysis conditions stored in the analysis condition area 103, and a simulation program stored in the program area 21, so as to execute circuit simulation.

With the simulation system shown in FIG. 1, layout information and electrical connection information for an integrated circuit to be subjected to circuit simulation are read from the input unit 50, and the CPU 10 selects circuit element models for corresponding circuit elements. In addition, the CPU 10 generates a to-be-analyzed circuit and executes circuit simulation. The circuit simulation results are output to the output unit 60.

The input unit 50 includes a keyboard, a mouse, a write pen, or a flexible disk unit. A simulation operator can specify input/output data and simulation conditions such as temperatures and errors via the input unit 50. In addition, analysis parameters such as output data formats and instructions such as execution or abortion of simulation can also be specified via the input unit 50. On the other hand, a display or a printer that displays simulation results, or a recording unit that stores data in a computer readable medium is available as the output unit 60. Here, the ‘computer readable medium’ means a medium capable of recording a program, such as a computer external memory unit, semiconductor memory, a magnetic disk, an optical disk, a magnetic optical disk, or a magnetic tape. More specifically, the ‘computer readable medium’ includes a flexible disk, CD-ROM, an MO disk, a cassette tape, and an open reel tape.

A circuit element model used for circuit simulation is described forthwith before describing a circuit simulation method using the circuit simulation system according to the first embodiment.

An integrated circuit is influenced by simultaneous switching when circuit elements sharing a primary main electrode region or a secondary main electrode region are conducting simultaneously. Here, the ‘primary main electrode region’ refers to a semiconductor region that is either an emitter region or a collector region when circuit elements are bipolar transistors (BJT) or insulated gate bipolar transistors (IGBT). On the other hand, it refers to a semiconductor region that is either a source region or a drain region when circuit elements are field-effect transistors (FET) or static induction transistors (SIT). Alternatively, it refers to a semiconductor region that is either an anode region or a cathode region when circuit elements are static induction thyristors (SI thyristors) or gate turn-off thyristors (GTO thyristors). The ‘secondary main electrode region’ refers to a semiconductor region that is either an emitter region or a collector region, which does not become the primary main electrode region, when circuit elements are BJIs or IGB's; or a semiconductor region that is either a source region or a drain region, which does not become the primary main electrode region, when circuit elements are FETs or SITs. Alternatively, the ‘secondary main electrode region’ refers to a semiconductor region that is either an anode region or a cathode region, which does not become the primary main electrode region, when circuit elements are SI thyristors or GTO thyristors. In short, when the primary main electrode region refers to an emitter region, the secondary main electrode region refers to a collector region; alternatively, when the former refers to a source region, the latter refers to a drain region; or when the former refers to a cathode region, the latter refers to an anode region.

In the following description, circuit elements refer to MOS transistors. An exemplary case of simultaneously switching those MOS transistors is described. That is, a case where executing circuit simulation considering simultaneously switching of MOS transistors sharing a source electrode region or a drain electrode region is described. In addition, a source electrode region or a drain electrode region shared by MOS transistors is referred to as a ‘common main electrode region’, as with other circuit elements.

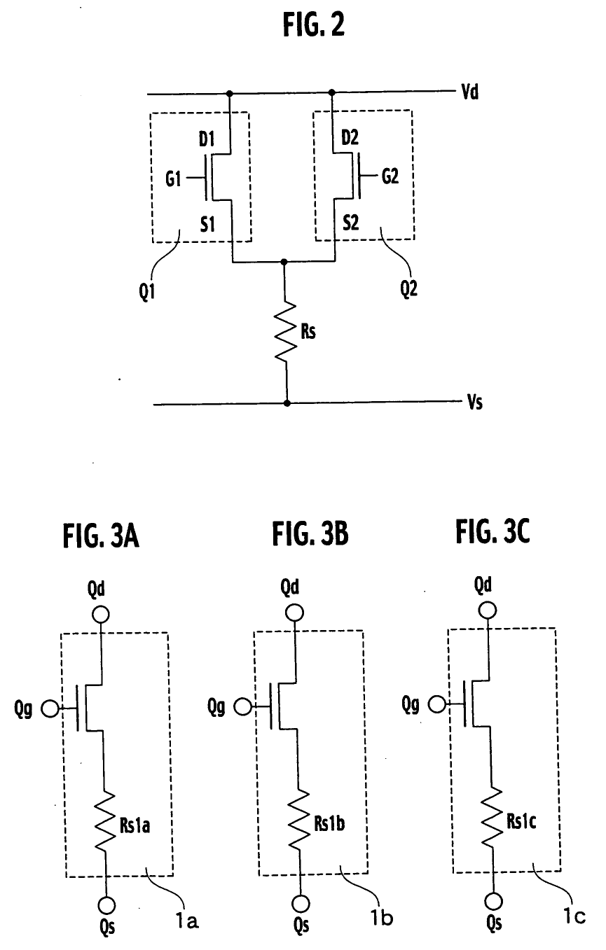

FIG. 2 is a partial circuit diagram of an integrated circuit, showing circuit elements Q1 and Q2 sharing a source electrode region, and parasitic resistance Rs of the source electrode region. The parasitic resistance Rs is one that is shared by the circuit elements Q1 and Q2. In other words, Rs is the parasitic resistance of the source electrode region through which current commonly flows when the circuit elements Q1 and Q2 are brought into conduction.

A gate electrode G1 of the circuit element Q1 is connected to the output terminal of another circuit element omitted in the drawing, and a drain electrode D1 is connected to a drain power supply line Vd. A source electrode S1 of the circuit element Q1 is connected to a source electrode S2 of the circuit element Q2 and one of the terminals of the parasitic resistance Rs. The other terminal of the parasitic resistance Rs is connected to a source power supply line Vs. A drain electrode D2 of the circuit element Q2 is connected to the drain power supply line Vd. A gate electrode G2 is connected to the output terminal of another circuit element that is omitted in the drawing. FIG. 2 shows an example of the drain electrode D1 of the circuit element Q1 and the drain electrode D2 of the circuit element Q2 being commonly connected to the drain power supply line Vd; alternatively, the drain electrode D1 of the circuit element Q1 and the drain electrode D2 of the circuit element Q2 may be connected to different drain power supply lines.

Hereinafter, circuit element models for the circuit elements Q1 and Q2 of the circuit diagram shown in FIG. 2 considering the influence of the parasitic resistance Rs are described.

Models 1a to 1c shown in FIGS. 3A to 3C are circuit diagrams showing exemplary circuit element models for the circuit element Q1 for circuit simulation considering simultaneous switching. The models 1a to 1c are obtained by modeling considering the influence of the parasitic resistance Rs upon the characteristics of the circuit element Q1 and differing depending on the behavior of the circuit element Q2 sharing the source electrode region. The model 1a models the circuit element Q1 including parasitic resistance Rs1a. The model 1b models the circuit element Q1 including parasitic resistance Rs1b. The model 1c models the circuit element Q1 including parasitic resistance Rs1c. The circuit element models respectively have a drain terminal referred to as Qd, a gate terminal referred to as Qg, and a source terminal referred to as Qs. The models 1a to 1c are selected as the simulation models for the circuit element Q1 in the following cases, respectively.

Model 1a: When the circuit element Q1 is conducting, and the circuit element Q2 is not simultaneously switched.

Model 1b: When the circuit element Q1 is conducting, and the circuit element Q2 is simultaneously switched.

Model 1c: When the circuit element Q1 is not conducting.

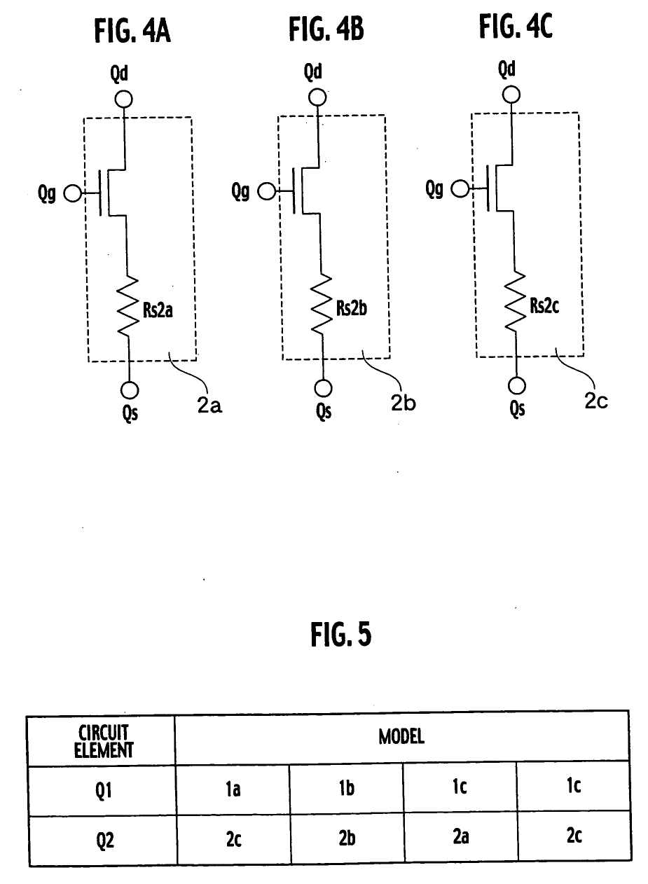

Similarly, the following circuit element models are provided for circuit simulation of the circuit element Q2. Models 2a to 2c shown in FIGS. 4S to 4C are circuit diagrams showing exemplary circuit element models for the circuit element Q2 for circuit simulation considering simultaneous switching. The model 2a models the circuit element Q2 including parasitic resistance Rs2a. The model 2b models the circuit element Q2 including parasitic resistance Rs2b. The model 2c models the circuit element Q2 including parasitic resistance Rs2c. The models 2a to 2c are applied to the circuit element Q2 in the following cases, respectively.

Model 2a: When the circuit element Q2 is brought into conduction, and the circuit element Q1 is not simultaneously switched.

Model 2b: When the circuit element Q2 is brought into conduction, and the circuit element Q1 is simultaneously switched.

Model 2c: When the circuit element Q2 is not conducting.

As is apparent from prerequisites for each model, the models 1a to 1c and 2a to 2c are not selected independently for the circuit elements Q1 and Q2, respectively, but selected in combinations shown in FIG. 5. For example, when the circuit element Q1 model is the model 1b, the circuit element Q2 model is the model 2b.

The parasitic resistances Rs1a to Rs1c and Rs2a to Rs2c included in corresponding models are specified considering current flowing from the circuit element Q1 and the circuit element Q2 to the parasitic resistance Rs when respective circuits are operating. For example, when the circuit element Q1 is brought into conduction, but the circuit element Q2 is not brought into conduction without any current flowing to the parasitic resistance Rs from the circuit element Q2, Rs1a=Rs. Alternatively, when the circuit elements Q1 and Q2 simultaneously switch on, and the same amount of current flows to the parasitic resistance from the circuit elements Q1 and Q2, Rs2a=Rs2b=Rs×2.

In the above description, exemplary models 1a to 1c including parasitic resistances are described as respective models for the circuit element Q1. According to another type of circuit element model, the structural configuration of each circuit element model to be used for a to-be-analyzed circuit may not be changed, however, a group of model parameters may be changed. In the case of the BSIM3 model, which is a MOS transistor element model and is widely used for circuit simulation, the parameters to be changed depending on the difference in parasitic resistance include parasitic resistance R_{DSW} per unit width, mobility μ₀, saturation speed V_{SAT}, long channel threshold voltage V_{TH0}, channel width offset fitting parameter W_{INT}, channel length offset fitting parameter L_{INT}, and the like.

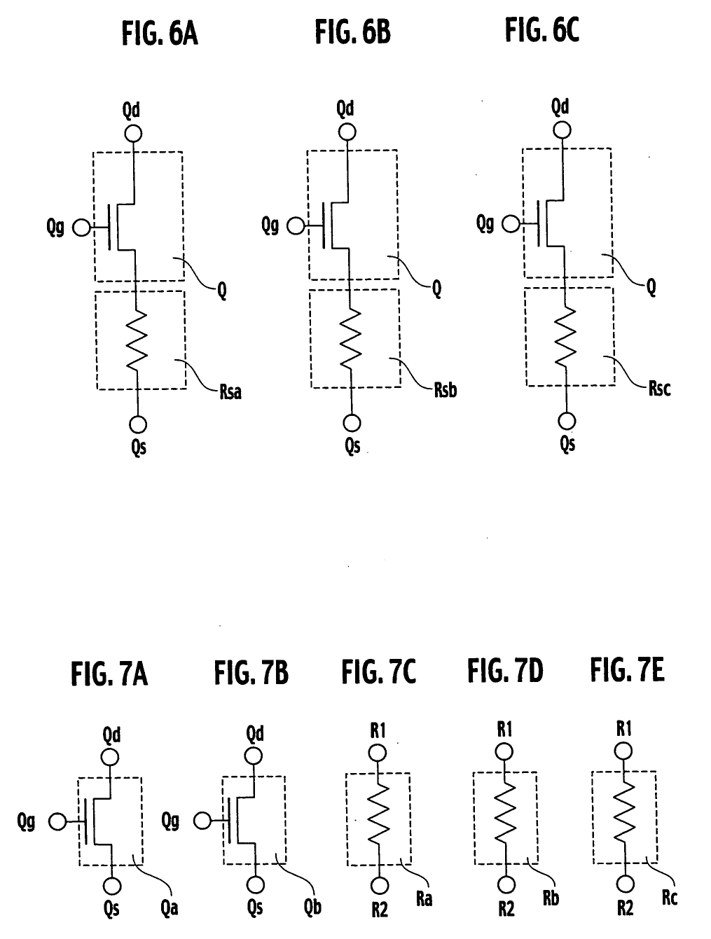

According to another type of circuit element model, a part thereof being influenced by parasitic resistance may be changed, while a part not being influenced by parasitic resistance may have a common circuit element model. FIGS. 6A to 6C show specific examples. FIG. 6A is a circuit element model made up of a combination of a circuit element model Q, which is a common section not influenced by parasitic resistance of the circuit element Q1, and a circuit element model Rsa, which is a section reflecting the influence upon the circuit element Q1 from parasitic resistance when the circuit element Q2 does not simultaneously switch. FIG. 6B is a circuit element model made up of a combination of the model Q and a circuit element model Rsb, which is a section reflecting the influence upon the circuit element Q1 from parasitic resistance when the circuit element Q2 simultaneously switches. FIG. 6C is a circuit element model made up of a combination of the model Q and a circuit element model Rsc, which is a section reflecting the influence upon the circuit element Q1 from parasitic resistance when the circuit element Q1 is not conducting. For example, in the circuit diagram shown in FIG. 2, when the circuit element Q1 is brought into conduction and the circuit element Q2 does not simultaneously switch, the element model shown in FIG. 6 Abecomes the model for the circuit element Q1.

Alternatively, according to another type of circuit element model, a parasitic resistance section may be separated from the other circuit element section, a plurality of circuit element models may be prepared for the respective sections, and they may be combined into a circuit element model. FIGS. 7A to 7E show specific examples. A circuit element model Qa shown in FIG. 7A or a circuit element model Qb shown in FIG. 7B and parasitic resistance models Ra, Rb, and Rc shown in FIGS. 7C to 7E are combined into a circuit element model for a circuit element including parasitic resistance. In FIGS. 7C to 7E, the terminals of the parasitic resistance models are referred to as R1 and R2. For example, a terminal Qs of the model Qa in FIG. 7A and the terminal R1 of the model Ra in FIG. 7C are connected to form a circuit element model for the circuit element Q1.

The above-described circuit element models considering the influence of simultaneous switching are only examples; other circuit element models considering electrical characteristics and parasitic resistance of the circuit element are further generated and stored in the library area 110.

A method of selecting circuit element models for the circuit elements Q1 and Q2, respectively, when the circuit element Q1 is conducting is described forthwith with reference to the circuit diagram shown in FIG. 2 as an example. Hereinafter, cases of selecting the models 1a to 1c shown in FIGS. 3A to 3C and the models 2a to 2c shown in FIGS. 4A to 4C as circuit element models are described. In order to select a circuit element model to be used for circuit simulation considering simultaneous switching, the behavior of other circuit elements sharing the source electrode region must be considered. However, when the behavior of a circuit element is determined according to combinations of input signals or the like, whether or not to simultaneously switch may be unclear. The case when it is unclear whether or not a transistor is conducting is referred to as ‘unkown’ forthwith. As a result, the following three cases of the behavior of the circuit element Q2 when the circuit element Q1 is brought into conduction can be considered.

Case 1: When the circuit element Q2 is not conducting.

Case 2: When the circuit element Q2 is conducting.

Case 3: When the circuit element Q2 is unknown.

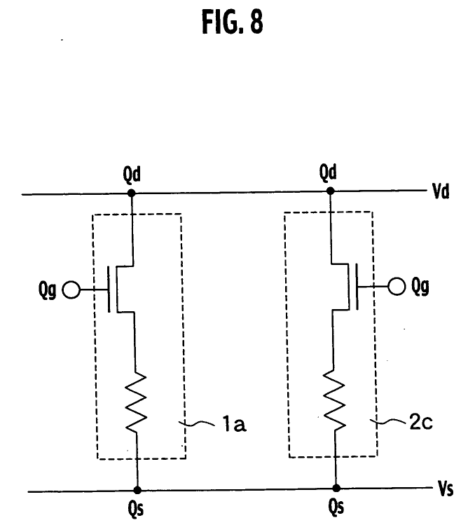

In case 1, as shown in FIG. 5, circuit element models to be selected for simulation are model 1a and model 2c for the circuit element Q1 and the circuit element Q2, respectively. In case 2, model 1b and model 2b are selected for the circuit element Q1 and the circuit element Q2, respectively. In case 3, since the circuit element Q2 is unknown, circuit simulation must be executed for both cases when the circuit element Q2 is conducting and not conducting. In other words, circuit simulation is executed for both cases 1 and 2. Accordingly, in case 3, circuit design has greater design margins than in cases 1 and 2. FIG. 8 shows a to-be-analyzed circuit of a circuit diagram shown in FIG. 2 of case 1.

On the other hand, when the circuit element Q1 is not conducting, the model 1c is selected for the circuit element Q1. In this case, when the circuit element Q2 is conducting, the model 2a is selected for the circuit element Q2. On the other hand, when the circuit element Q2 is not conducting, the model 2c is selected for the circuit element Q2. Alternatively, if both circuit elements Q1 and Q2 are unknown, circuit simulation must be executed for several cases, such as the case of simultaneously switching, the case of both circuit elements not conducting, and the like.

An example of selecting one of the models 1a to 1c for the circuit element Q1 and one of the models 2a to 2c for the circuit element Q2 is described above. Alternatively, for example, when an identical circuit element to the circuit element Q1 is used for the circuit element Q2 in circuit simulation, one of the models 1a to 1c is selected for the circuit element Q2.

The case where more than three circuit elements share a source electrode region can be considered as with the case where two circuit elements share a source electrode region. In other words, considering how many circuit elements are conducting simultaneously and taking into account the amount of current flowing from each circuit element to the parasitic resistance, parasitic resistance parameters are specified, and a circuit element model therewith is generated. If there are many unknown circuit elements, circuit simulation must be executed for both cases of unknown circuit elements conducting and not conducting. Therefore, if there is an unknown circuit element, circuit design requires greater design margins; however, if any circuit elements that are simultaneously switched or not simultaneously switched are determined, circuit design with a small design margin can be implemented.

An exemplary case of MOS transistors sharing the source electrode region is described above; alternatively, in the case of MOS transistors sharing a drain electrode region, generating a circuit element model considering the parasitic resistance of the drain electrode region may also execute highly accurate circuit simulation. Furthermore, in the case of a semiconductor device using transistors other than MOS transistors, generating a circuit element model considering the parasitic resistance of a common main electrode region may also execute circuit simulation considering the influence of simultaneous switching.

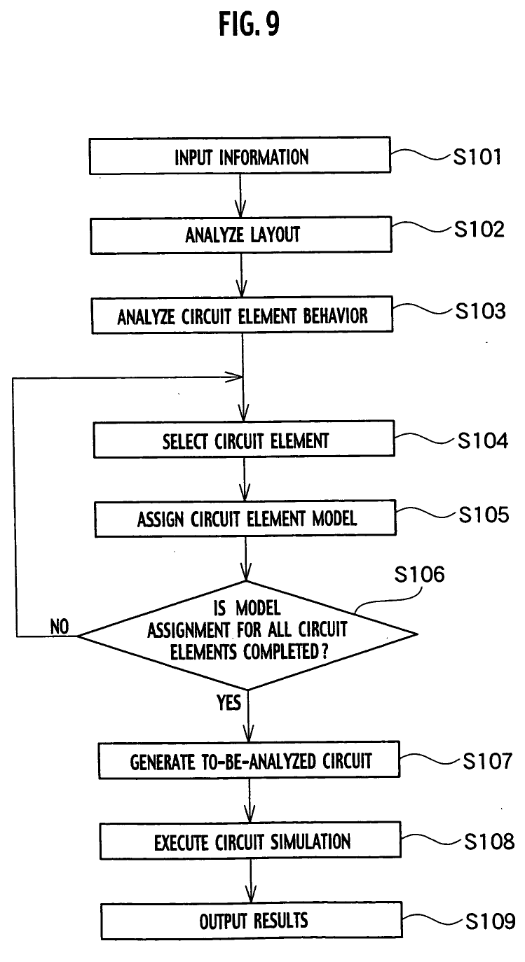

An example of a circuit simulation method using the circuit simulation system shown in FIG. 1 is described with reference to a flowchart shown in FIG. 9. An exemplary case of simultaneously switching of MOS transistors sharing a main electrode region is described forthwith.

(a) In step S101 of FIG. 9, layout information of circuit elements in a circuit to be subjected to circuit simulation is stored in the layout information area 101 via the input unit 50 shown in FIG. 1. In addition, electrical connection information of a circuit to be subjected to circuit simulation is stored in the connection information area 102 via the input unit 50. Furthermore, analysis conditions for executing circuit simulation are stored in the analysis condition area 103 via the input unit 50.

(b) In step S102, the layout analysis module 11 reads the layout information of the circuit elements stored in the layout information area 101, and analyzes the layout of the circuit elements. In addition, information of the MOS transistors sharing the main electrode region is extracted and stored in the location information area 111.

(c) In step S103, the circuit behavior analysis module 12 reads the electrical connection information stored in the connection information area 102, and analyzes MOS transistor behaviors. Behavior information of whether or not respective MOS transistors are conducting or are unknown is additionally stored in the behavior information area 112.

(d) In step S104, the model selection module 13 selects a MOS transistor for which a circuit element model is selected.

(e) In step S105, the information of MOS transistors sharing the electrode region stored in the location information area 111 and the behavior information for the MOS transistors stored in the behavior information area 112 are read to analyze whether or not there is another MOS transistor sharing the electrode region with the MOS transistor selected by the model selection module 13 in step S104, and whether or not that MOS transistor sharing the electrode region simultaneously switches. The model selection module 13 selects a circuit element model for the MOS transistor based on the analysis results using the aforementioned method. Typically, the circuit element models for corresponding MOS transistors sharing the electrode region can be selected simultaneously. The selected circuit element models are stored in the model information area 113 as information of respective MOS transistors.

(f) In step S106, whether or not circuit element models have been selected for all MOS transistors is determined. If there is a MOS transistor for which a circuit element model is not yet selected, the process returns to step S104, and a circuit element model for the next MOS transistor is selected. If circuit element models have been selected for all MOS transistors, the process proceeds to step S107.

(g) In step S107, the circuit generation module 14 reads the electrical connection information of a circuit to be subjected to circuit simulation stored in the connection information area 102, and generates a to-be-analyzed circuit using the circuit element models for the circuit elements stored in the library area 110 while referencing the model information selected for respective MOS transistors stored in the model information area 113. The generated, to-be-analyzed circuit is stored in the circuit information area 114.

(h) In step S108, the circuit simulation module 15 reads the to-be-analyzed circuit stored in the circuit information area 114, the setting conditions stored in the analysis condition area 103, and an analysis program stored in the program area 21, executing circuit simulation. The circuit simulation results are stored in the analysis result area 115.

(i) In step S109, the simulation results are read from the analysis result area 115 and output via the output unit 60.

An example where circuit element layouts are analyzed first in step S102, and circuit element behavior information is then analyzed in step S103 is described above; however, analysis may be executed in the reverse order. Alternatively, a method of grouping circuit elements sharing an electrode region in step S102, and selecting circuit element models for all circuit elements within each group in step S105 is available.

With the simulation system according to the first embodiment of the present invention, analysis of circuit element layout information and electrical connection information allows implementation of highly accurate circuit simulation considering the influence of simultaneous switching upon a semiconductor device.

A sequence of simulation shown in FIG. 9 may be executed by controlling the simulation system shown in FIG. 1 using a software program equivalent to the algorithm shown in FIG. 9. This program should be stored in the program memory unit 20, which is included in the simulation system shown in FIG. 1. In addition, a successive simulation of the present invention may be executed by storing this program in the computer readable medium, and making the program memory unit 20 shown in FIG. 1 read the content of that medium.

### Second Embodiment

Characteristics of a circuit element such as a transistor may change due to temperature change emanating from power consumption of adjacent circuit blocks and the like. The power consumption of a circuit block is determined depending on the circuit behavior of the circuit block. More specifically, an amount of current flowing to each circuit element in the circuit block is determined by whether or not the circuit elements included in the circuit block are conducting, and power consumption of the circuit block can be calculated based on that amount of current. Whether or not the circuit elements are conducting can be determined by circuit behavior based on the circuit connection information. Accordingly, power consumption of the circuit block can be estimated from the electrical connection information of the circuit block. In addition, the amount of change in temperature of a circuit element due to power consumption of a circuit block depends on the distance from the circuit block and the thermal conductivity of an interconnect that connects the circuit block and the circuit element. Therefore, the influence of power consumption of adjacent circuits upon the circuit elements can be estimated from the circuit element layout information and circuit electrical connection information, and highly accurate circuit simulation can be executed using a circuit element model considering changes in the circuit element characteristics due to temperature change. According to a method of selecting a circuit element model considering a change in characteristics due to temperature change, circuit element models for a circuit element representing characteristics at several temperatures are generated, and a circuit element model is then selected based on temperature dependence of characteristics of the circuit element. The respective circuit element models at each temperature can be generated by measuring, for example, temperature characteristics of the circuit element. The generated circuit element models are stored in the library area 110.

In addition, when an amount of current flowing to the adjacent circuit blocks changes, noise occurs in the power supply line or semiconductor substrate that may affect the characteristics of a circuit element such as a transistor. The change in the amount of current causing noise depends on the behavior of a circuit block. More specifically, the generated amount of noise can be calculated from the rate of change in the total amount of current to the time when the circuit elements included in the circuit block simultaneously switch. Accordingly, the amount of noise generated in a circuit block can be estimated from the electrical connection information of the circuit block. In addition, the amount of change in circuit element characteristics due to the noise generated in the circuit block depends on the distance from the location where the noise occurs. Therefore, the influence of the noise generated in the adjacent circuits upon the circuit elements can be estimated using the circuit element layout information and the circuit electrical connection information. Highly accurate circuit simulation can be executed by generating and storing a plurality of circuit element models in the library area 110 considering the changes in circuit element characteristics due to noise, and selecting a circuit element model based on the estimated change in characteristics due to the noise.

According to a method of selecting a circuit element model considering a change in temperature and the influence of noise, other than selecting a circuit element model itself, a group of model parameters may be changed without changing the circuit element model. The model parameters to be changed include a long channel threshold voltage V_{TH0}, mobility μ₀, and a saturation speed V_{SAT} in the case of the BSIM3 model, for example.

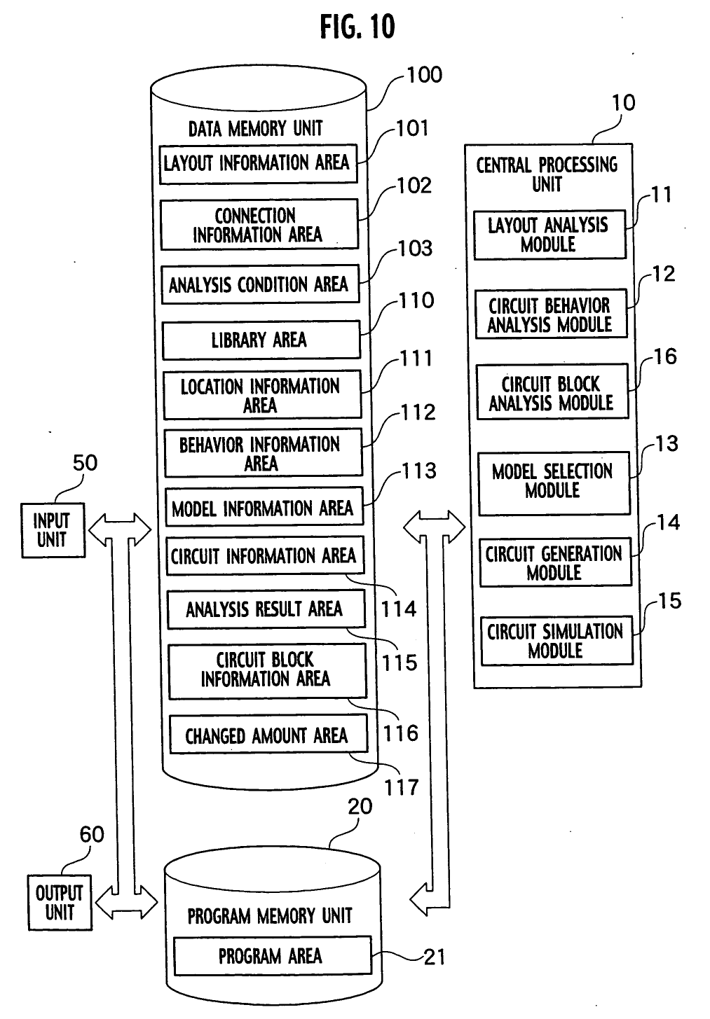

As shown in FIG. 10, a circuit simulation system according to a second embodiment of the present invention includes the CPU 10, the program memory unit 20, the data memory unit 100, the input unit 50, and the output unit 60, which are used to execute circuit simulation considering the influence of power consumption of adjacent circuit blocks or the generated noise. The data memory unit 100 includes the layout information area 101, the connection information area 102, the analysis condition area 103, the library area 110, the location information area 111, the behavior information area 112, the model information area 113, the circuit information area 114, the analysis result area 115, a circuit block information area 116, and a changed amount area 117. In addition, the program memory unit 20 includes the program area 21.

Furthermore, the CPU 10 includes the layout analysis module 11, the circuit behavior analysis module 12, the model selection module 13, the circuit generation module 14, the circuit simulation module 15, and a circuit block analysis module 16.

There is a difference from the circuit simulation system according to the first embodiment in that the circuit block information area 116, the changed amount area 117, and the circuit block analysis module 16 are further included. The circuit block analysis module 16 analyzes characteristics of a circuit block and calculates power consumption and the amount of noise in circuit blocks or the like. The circuit block information area 116 stores the calculated power consumption and the amount of noise in the circuit blocks or the like. The changed amount area 117 stores the amount of change in temperature and the amount of noise in circuit elements.

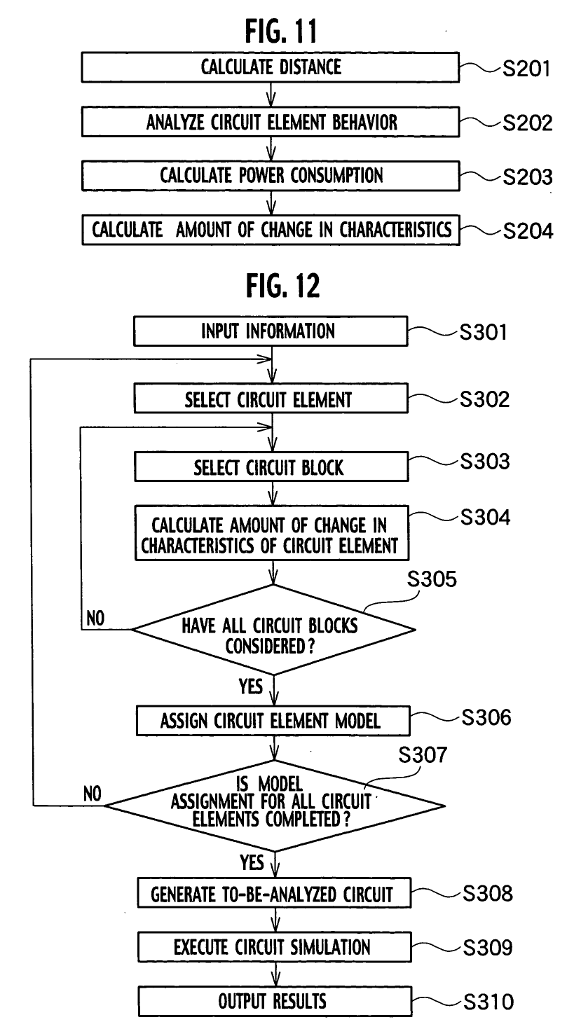

An exemplary method of calculating power consumption of a circuit block and the amount of change in temperature of a circuit element emanating from power consumption of the circuit block using the circuit simulation system shown in FIG. 10 is described forthwith with reference to a flowchart shown in FIG. 11.

(a) To begin with, in step S201 of FIG. 11, the layout analysis module 11 shown in FIG. 10 reads layout information of a circuit element to be subjected to circuit simulation stored in the layout information area 101, and analyzes the layout of the circuit element. The layout analysis module 11 calculates the distance between a circuit element for which a circuit element model is selected and a circuit block for which power consumption is calculated. The calculated distance information is stored in the location information area 111.

(b) Next, in step S202, the circuit behavior analysis module 12 reads the electrical connection information of a circuit to be subjected to circuit simulation stored in the connection information area 102, and analyzes circuit behavior. The circuit behavior analysis module 12 analyzes the behaviors of the circuit elements, which are included in a circuit block for which power consumption is calculated, and behavior information of whether or not each circuit element is conducting is additionally stored in the behavior information area 112.

(c) In step S203, the circuit block analysis module 16 reads the circuit electrical connection information stored in the connection information area 102 and the circuit element behavior information of a circuit block stored in the behavior information area 112 to calculate power consumption of the circuit block. The calculated power consumption is stored in the circuit block information area 116.

(d) In step S204, the circuit block analysis module 16 reads information of the distance and the electrical connection between the circuit element for which a circuit element model stored in the location information area 111 is selected and the circuit block for which power consumption is calculated, and power consumption of the circuit block stored in the circuit block information area 116, and then calculates the amount of change in the temperature of a circuit element for which a circuit element model is selected, considering the thermal conductivity of the substrate and interconnects that connect the circuit element for which a circuit element model is selected to the circuit block for which power consumption is calculated. The amount of change in the temperature of the circuit element is stored in the changed amount area 117.

A case of a single circuit block influencing a circuit element for which a circuit element model is selected is described above. If the circuit element is influenced by power consumption of a plurality of circuit blocks, the total amount of change in temperature due to the power consumption of each circuit block generally represents the amount of change in the temperature of the circuit element.

Next, an exemplary method of selecting a circuit element model considering the influence of power consumption of a circuit block so as to execute circuit simulation using the circuit simulation system shown in FIG. 10 is described forthwith with reference to a flowchart shown in FIG. 12.

(a) In step S302 of FIG. 12, the model selection module 13 shown in FIG. 10 selects a circuit element for which a circuit element model is selected.

(b) In step S303, the circuit block analysis module 16 selects a circuit block for which power consumption is calculated.

(c) In step S304, the amount of change in the temperature of the circuit element due to power consumption of the selected circuit block is stored in the changed amount area 117 using the method described with FIG. 11.

(d) In step S305, it is determined whether or not the amount of change in the temperature of the circuit element due to power consumption of all circuit blocks has been calculated. If there is a circuit block for which the amount of change in the temperature of the circuit element due to power consumption has not yet been calculated, the process returns to step S303 in which the next circuit block is then selected. If calculation of the amount of change in the temperature of the circuit element due to power consumption of all circuit blocks is finished, the process proceeds to step S306.

(e) In step S306, the model selection module 13 reads the amount of change in temperature stored in the changed amount area 117, and selects a circuit element model for the circuit element based on the amount of change in temperature. The selected circuit element models are stored in the model information area 113 as corresponding circuit element information.

(f) In step S307, it is determined whether or not circuit element models have been selected for all circuit elements. If there is a circuit element for which a circuit element model has not yet been selected, the process returns to step S302 in which the next circuit element model is then selected. If circuit element models have been selected for all the circuit elements, the process proceeds to step S308.

With the simulation system according to the second embodiment of the present invention, analysis of circuit layout information and electrical connection information allows the selection of a circuit element model considering the influence of power consumption of a circuit block. This allows implementation of highly accurate circuit simulation. Since the rest is basically the same as the circuit simulation system according to the first embodiment, a repetitive description is omitted.

A circuit simulation method considering a change in the temperature of a circuit element due to power consumption of a circuit block is described above; alternatively, a circuit simulation method considering the influence of power consumption of a transistor or a logic gate may also be implemented.

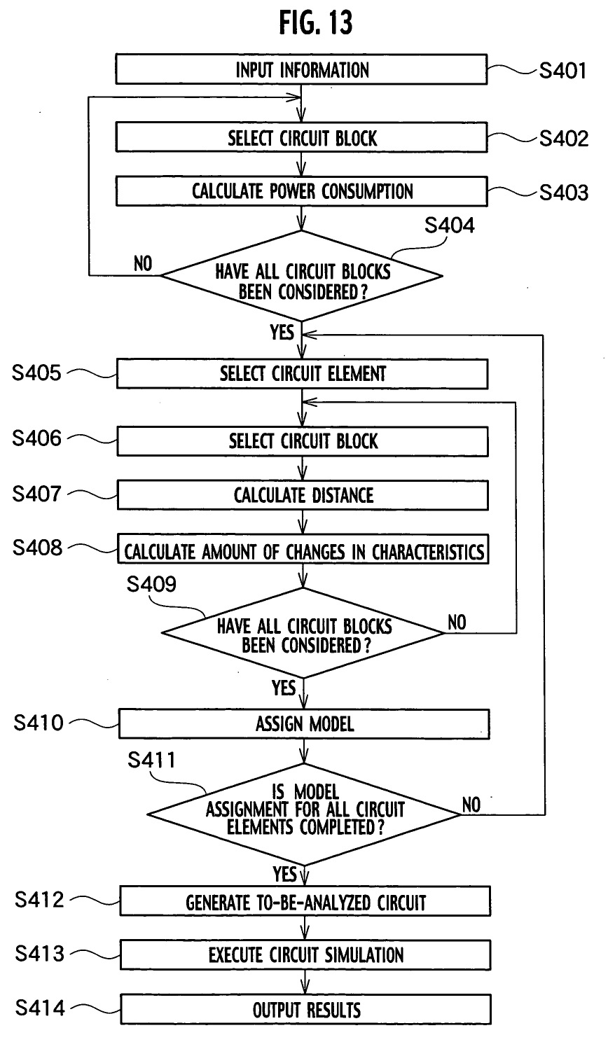

The flowchart shown in FIG. 12 shows an example where to begin with, in step S302, a circuit element for which a circuit element model selected is selected, and in step S304, power consumption of the circuit block is then calculated so as to calculate the amount of change in the temperature of the circuit element. If there are a plurality of circuit blocks, circuit element models can be selected by calculating power consumption of all circuit blocks first, and then calculating the amount of change in the temperature of each circuit element. Another circuit simulation method considering temperature dependence of the circuit element due to power consumption of a circuit block using the circuit simulation system shown in FIG. 10 is described with reference to FIGS. 10 and 13.

(a) In step S402 of FIG. 13, the circuit block analysis module 16 shown in FIG. 10 selects a circuit block for which power consumption is calculated.

(b) In step S403, power consumption of the circuit block is calculated using the method described in FIG. 11. The calculated power consumption is then stored in the circuit block information area 116.

(c) In step S404, it is determined whether or not power consumption of all circuit blocks have been calculated. If there is a circuit block for which power consumption has not yet been calculated, the process returns to step S402 in which the next circuit block is then selected. If calculation of power consumption of all circuit blocks is finished, the process proceeds to step S405.

(d) In step S405, the model selection module 13 selects a circuit element for which a circuit element model is selected.

(e) In step S406, the circuit block analysis module 16 selects a circuit block for which the influence of power consumption upon a circuit element is calculated.

(f) In step S407, the distance between the selected circuit block and the circuit element is calculated using the method described in FIG. 11. The calculated distance is stored in the location information area 111.

(g) In step S408, the amount of change in the temperature of the circuit element due to power consumption of a circuit block is calculated using the method described in FIG. 11. The calculated amount of change in temperature is stored in the changed amount area 117.

(h) In step S409, it is determined whether or not the amount of change in the temperature of a circuit element due to power consumption of all circuit blocks has been calculated. If there is a circuit block for which calculation is not yet finished, the process returns to the step S406 in which the next circuit block is then selected. If calculation of the amount of change in the temperature of a circuit element due to power consumption of all circuit blocks is finished, the process proceeds to step S410.

(i) In step S410, the model selection module 13 reads the amount of change in temperature stored in the changed amount area 117, and selects a circuit element model. The selected circuit element model is stored in the model information area 113 as corresponding circuit element information.

0) In step S411, it is determined whether or not circuit element models have been selected for all the circuit elements. If there is a circuit element for which a circuit element model has not yet been selected, the process returns to step S405 in which the next circuit element model is then selected. If circuit element models have been selected for all the circuit elements, the process proceeds to step S412.

Even with the method shown in FIG. 13, circuit simulation can be executed by selecting a circuit element model considering the influence of power consumption of the circuit block. Since the rest is basically the same as the circuit simulation method shown in FIG. 12, a repetitive description is omitted.

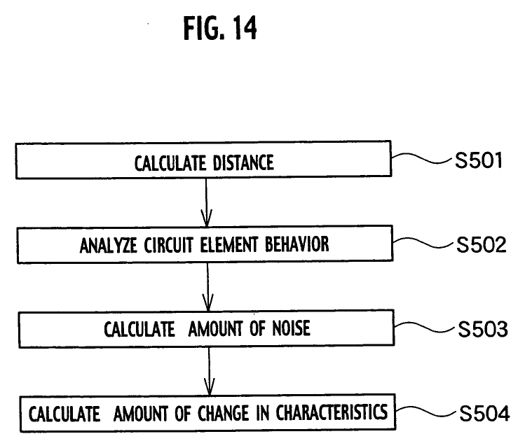

Next, an exemplary method of selecting a circuit element model considering noise power dependence of characteristics is described with reference to the flowcharts shown in FIGS. 10 and 14.

(a) In step S501 of FIG. 14, the layout analysis module 11 shown in FIG. 10 reads layout information of a circuit element to be subjected to circuit simulation stored in the layout information area 101 via the input unit 50, and analyzes the layout of the circuit element. The layout analysis module 11 calculates the distance between the circuit element for which a circuit element model is selected and the circuit block for which the generated amount of noise is calculated. The calculated distance information is stored in the location information area 111.

(b) In step S502, the circuit behavior analysis module 12 reads electrical connection information of a circuit to be subjected to circuit simulation stored in the connection information area 102 via the input unit 50, and analyzes circuit behavior. The circuit behavior analysis module 12 analyzes behaviors of the circuit elements, which are included in the circuit block for which the generated amount of noise is calculated, and behavior information of whether or not each circuit element is conducting is additionally stored in the behavior information area 112.

(c) In step S503, the circuit block analysis module 16 reads the behavior information of the circuit elements in a circuit block stored in the behavior information area 112 and circuit electrical connection information stored in the connection information area 102, calculates the total amount of current that changes depending on simultaneous switching of circuit blocks, and estimates the amount of developing noise. The calculated amount of noise generated in the circuit block is stored in the circuit block information area 116.

(d) In step S504, the circuit block analysis module 16 reads information of the distance between the circuit block of which the amount of noise is calculated and the circuit element for which a circuit element model stored in the location information area 111 is selected, and the amount of circuit block noise stored in the circuit block information area 116, and then calculates an amount of noise, which may influence the circuit element for which a circuit element model is selected, in view of the dielectric constant of the semiconductor substrate on which the integrated circuit is mounted. The amount of noise is stored in the changed amount area 117.

The case of a single circuit block influencing the circuit element for which a circuit element model is selected is described above. If a circuit element is influenced by the noise generated in a plurality of circuit blocks, the total amount of noise generated in each circuit block represents the amount of noise influencing the circuit element.

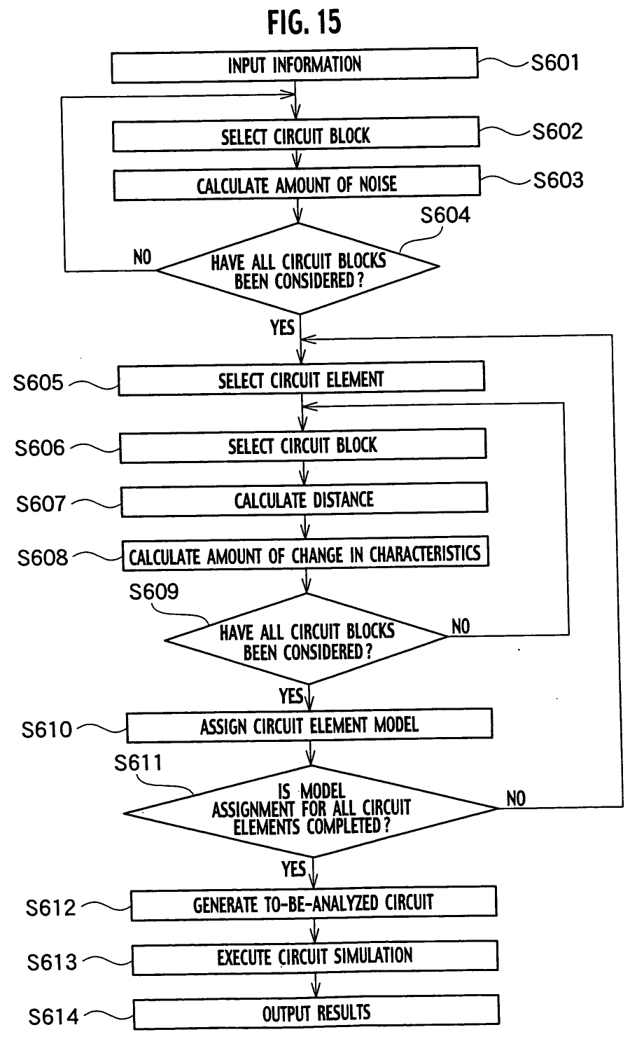

Next, an exemplary method of selecting a circuit element model considering the influence of noise so as to execute circuit simulation using the circuit simulation system shown in FIG. 10 is described forthwith with reference to a flowchart shown in FIG. 15.

(a) In step S602 of FIG. 15, the circuit block analysis module 16 shown in FIG. 10 selects a circuit block from which the amount of noise is calculated.

(b) In step S603, the amount of noise generated in the circuit block is stored in the circuit block information area 116 using the method described in FIG. 14.

(c) In step S604, it is determined whether or not the amount of noise in all circuit blocks has been calculated. If there is a circuit block from which the amount of noise has not yet been calculated, the process returns to step S602, and the next circuit block is selected. If the calculation of the amount of noise from all the circuit blocks is finished, the process proceeds to step S605.

(d) In step S605, the model selection module 13 selects a circuit element for which a circuit element model is selected.

(e) In step S606, the circuit block analysis module 16 selects a circuit block for which influence of noise upon circuit elements is calculated.

(f) In step S607, the distance between the circuit element for which a simulation model is selected and the circuit block is stored in the location information area 111 using the method described in FIG. 14.

(g) In step S608, the circuit block analysis module 16 stores the amount of noise influencing the circuit element for which a simulation model is selected, which is calculated based on the amount of noise stored in the circuit block information area 116 and the distance between the circuit block and the circuit element stored in the location information area 111 using the method described in FIG. 14.

(h) In step S609, it is determined whether or not the amount of noise influencing the circuit element due to the noise generated in all circuit blocks has been calculated. If there is a circuit block from which the amount of noise influencing the circuit element due to the generated noise has not yet been calculated, the process returns to step S606, and the next circuit block is selected. If calculation of the amount of noise influencing the circuit element due to the noise generated in all the circuit blocks is finished, the process proceeds to step S610.

(i) In step S610, the model selection module 13 reads the amount of noise stored in the changed amount area 117, and selects a circuit element model for the circuit element. The selected circuit element model is then stored in the model information area 113 as corresponding circuit element information.

(j) In step S611, it is determined whether or not circuit element models have been selected for all the circuit elements. If there is a circuit element for which a circuit element model has not yet been selected, the process returns to step S605, and the next circuit element model selection is performed. If circuit element models have been selected for all the circuit elements, the process proceeds to step S612.

With the method shown in FIG. 15, analysis of circuit layout information and electrical connection information allows the selection of a circuit element model for a circuit element considering the influence of noise generated in a circuit block. This allows implementation of highly accurate circuit simulation considering the amount of noise in adjacent circuits. Since the rest is basically the same as in the circuit simulation method shown in FIG. 12, a repetitive description is omitted.

In a typical integrated circuit design task, a logic circuit is designed so as to have desired circuit characteristics, and layout of that circuit is then designed based on a logic circuit diagram using a CAD system. The circuit simulation system according to the first and the second embodiment of the present invention allows implementation of highly accurate circuit simulation with a short analysis time using circuit element layout information included in circuit layout information, and electrical connection information included in logic circuit information. If a malfunction is found as a result of circuit simulation and analysis, the logic design or the circuit layout can be modified before fabricating the integrated circuit. Fabrication of the integrated circuit after modification allows achievement of the desired circuit characteristics. If the accuracy of circuit simulation is insufficient, the fabricated integrated circuit does not satisfy the desired circuit characteristics. Therefore, logic design or circuit layout design has to be made again after fabrication of the integrated circuit. As a result, execution of a highly accurate circuit simulation using the circuit simulation system according to the first and the second embodiment of the present invention allows a reduction in development time of integrated circuits and a decrease in the development cost.

### Other Embodiments

While the case of considering the influence of parasitic resistance due to simultaneous switching is described in the first embodiment, a highly accurate circuit simulation system may be implemented by generating a circuit element model considering parasitic inductance or parasitic capacitance.

Various modifications will become possible for those skilled in the art after receiving the teachings of the present disclosure without departing from the scope thereof

1. A circuit simulation system for simulating an integrated circuit, comprising:
a data memory unit configured to include a library area storing a plurality of circuit element models and a connection information area storing connection information of the integrated circuit;
a circuit behavior analysis module configured to analyze behavior information of a circuit element of the integrated circuit based on the connection information;
a model selection module configured to select a circuit element model corresponding to the circuit element from the library area based on location information and the behavior information of the circuit element;
a circuit generation module configured to generate a to-be-analyzed circuit using the selected circuit element model; and
a circuit simulation module configured to execute the to-be-analyzed circuit simulation.

2. The system of claim 1, wherein the behavior information includes switching information of the circuit element.

3. The system of claim 1, wherein the location information includes information of the circuit elements sharing an electrode region.

4. The system of claim 1, further comprising a circuit block analysis module configured to read the connection information from the connection information area and to analyze characteristics of a circuit block.

5. The system of claim 4, wherein the connection information includes information of a power consumption of the circuit block.

6. The system of claim 4, wherein the connection information includes information of noise generated in the circuit block.

7. The system of claim 1, further comprising a layout analysis module configured to analyze circuit element layout information of the integrated circuit and to extract the location information based on the circuit element layout information:

8. A computer implemented method for simulating an integrated circuit, comprising:
generating a plurality of circuit element models for a single circuit element, and storing the circuit element models in a library area;
analyzing behavior information of a circuit element of the integrated circuit based on connection information of the integrated circuit;
selecting a circuit element model for the circuit element from the library area based on location information and the behavior information of the circuit element;
generating a to-be-analyzed circuit using the circuit element model; and
executing the to-be-analyzed circuit simulation.

9. The method of claim 8, wherein the behavior information includes switching information of the circuit element.

10. The method of claim 8, wherein the location information includes information of the circuit elements sharing an electrode region.

11. The method of claim 8, further comprising analyzing characteristics of a circuit block based on the connection information.

12. The method of claim 11, wherein the characteristics include information of a power consumption of the circuit block.

13. The method of claim 11, wherein the characteristics include information of noise generated in the circuit block.

14. The method of claim 8, further comprising extracting the location information based on layout information of the integrated circuit.

15. The method of claim 8, wherein the circuit element model is selected based on current flowing through the circuit element.

16. The method of claim 8, wherein the circuit element model is selected based on temperature dependence of characteristics of the circuit element.

17. The method of claim 8, wherein the circuit element model is selected based on noise power dependence of characteristics of the circuit element.

18. A computer program product for executing a circuit simulation, comprising:
instructions configured to analyze behavior information of a circuit element of an integrated circuit based on connection information of the integrated circuit;
instructions configured to select a circuit element model for the circuit element from a library area based on location information and the behavior information of the circuit element;
instructions configured to generate a to-be-analyzed circuit using the circuit element model; and
instructions configured to execute the to-be-analyzed circuit simulation.

19. The computer program product of claim 18, further comprising instructions configured to extract the location information based on layout information of the integrated circuit.
